(19) United States
(12) Patent Application Publication
(10) Pub. No.: US 2013/0207015 A1
(43) Pub. Date: Aug. 15, 2013

(54) Solenoid Valve, and Method for Producing such a Solenoid Valve

(71) Applicants: Elmar Vier, Freiberg (DE); Norbert Alaze, Markgroeningen (DE)

(72) Inventors: Elmar Vier, Freiberg (DE); Norbert Alaze, Markgroeningen (DE)

(73) Assignee: Robert Bosch GmbH, Stuttgart (DE)

(21) Appl. No.: 13/519,579

(22) PCT Filed: Nov. 5, 2010
(86) PCT No.: PCT/EP10/66875

§ 371 Date: Oct. 2, 2012

(30) Foreign Application Priority Data
Dec. 29, 2009 (DE) 10 2009 055 346.0

(51) Int. Cl. F16K 31/06

(52) U.S. Cl. CPC F16K 31/06
USPC 251/129.15; 29/890.12

(57) ABSTRACT

A solenoid valve includes a core sleeve, in which a valve needle can be arranged in a longitudinally displaceable manner. The core sleeve has at least one radial opening in the casing wall thereof. The core sleeve further has a first sub-sleeve and a second sub-sleeve that axially adjoins the first sub-sleeve. The radial opening in the connecting region is designed as an end face axial recess in at least one of the sub-sleeves. A method for producing such a solenoid valve is also disclosed.

The invention relates to a solenoid valve comprising a core sleeve in which a valve needle can be arranged in a longitudinally displaceable fashion, wherein the core sleeve has at least one radial opening in its casing wall.

In addition, the invention relates to a method for producing a solenoid valve which has a core sleeve in which a valve needle can be arranged in a longitudinal and displaceable fashion, and which is provided with at least one radial opening.

### PRIOR ART

Solenoid valves and method for producing the type mentioned at the beginning are known from the prior art. They are used, for example, as open-loop and/or closed-loop control valves in hydraulic devices, for example in brake systems of motor vehicles. For this purpose, the solenoid valves have at least one core sleeve in which a valve needle is arranged or mounted in a longitudinally displaceable fashion. The interior of the core sleeve usually serves as a flow duct for the fluid which is to be open-loop or closed-loop controlled. By activating the valve needle, the fluid can be discharged in a metered fashion through a radial opening which is formed in the casing wall of the core sleeve and is generally embodied as a transverse drilled hole. The metal-cutting processing of the core sleeve, which is generally embodied as a turned part, results in high production costs.

### DISCLOSURE OF THE INVENTION

The invention provides that the core sleeve has a first component sleeve and a second component sleeve which axially adjoins the first component sleeve, wherein the radial opening is embodied as an end-face axial cutout in the connecting region in at least one of the component sleeves. There is therefore provision that the core sleeve is embodied in two parts, wherein the two component sleeves bear axially one against the other. The radial opening is provided in the connecting region, that is to say in the region in which the two component sleeves bear one against the other with their end sides facing one another. The radial opening is embodied here as an axial cutout in an end side of at least one of the component sleeves, with the result that the radial opening is ultimately defined by the interplay of the two component sleeves. The axial cutout therefore has, for example, a U-shaped longitudinal section and is closed off at its free side by the closed end side of the component sleeve lying opposite. The embodiment as an end-side axial cutout makes it possible already to form or embody the radial opening when the component sleeves are originally shaped. This is an extra need for complex and costly metal-cutting processing, which would otherwise be necessary to produce the transverse drill hole.

The radial opening is advantageously embodied as an axially oriented elongate hole. The length of the radial opening is therefore greater than its width, wherein its longitudinal axis is oriented axially with respect to the core sleeve or the corresponding component sleeve. As a result, the radial opening is given the U-shaped longitudinal sectional form already mentioned above. Of course, it is also conceivable to form the radial opening in the form of the semicircle or with sharp angles. The elongate hole is preferably formed essentially by only one of the component sleeves or so that the other component sleeve axially terminates the elongate hole with its closed end side. However, it is, of course, also conceivable for the radial opening or the elongate hole to be formed by two axial cutouts, lying opposite one another, in one of the component sleeves in each case.

The component sleeves are preferably caulked to one another in the connecting region by means of plastic deformation. The caulking ensures a frictionally locking and positively locking connection between the two component sleeves of the core sleeve. The plastic deformation ensures a particularly secure and reliable connection here, which can be produced easily.

For this purpose, the first component sleeve has expediently at the end side an axial receptacle in the connecting region, in which axial receptacle the second component sleeve rests in certain areas. The first component sleeve therefore has, on its end side assigned to the second component sleeve, a receptacle or depression whose internal diameter corresponds at least essentially to the external diameter of the second sleeve, the end side of which faces the first component sleeve. The axial receptacle is expediently oriented coaxially with respect to the component sleeve or core sleeve. If the second component sleeve rests in the axial receptacle in certain areas, the second component sleeve can be caulked therein in the region of the axial receptacle through plastic deformation of the first component sleeve. The caulking is preferably implemented here by an at least essentially radial application of force to the first component sleeve.

Furthermore, there is provision that the second component sleeve has at least one radial projection, in particular a radial web extending over the entire circumference in the connecting region. The radial projection or radial web server as securing means for the plastically deformed material of the first component sleeve.

Finally there is provision that the axial extent of the radial projection is smaller than the axial extent of the axial receptacle. In other words, the height of the radial projection is smaller than the depth of the axial receptacle, with the result that if the second component sleeve rests in the axial receptacle of the first component sleeve, the first component sleeve engages completely over the radial projection. During the caulking, the plastic deformation causes the material of the first component sleeve to be advantageously forced behind the radial projection, where the first component sleeve engages behind the second component sleeve on the radial projection thereof, as a result of which a positively locking connection is ensured axially between the first and second component sleeves. Finally, the first component sleeve therefore engages around the radial projection or radial web of the second component sleeve.

The method according to the invention for producing a solenoid valve is distinguished by the fact that the core sleeve is formed from a first component sleeve and a second component sleeve which adjoins the first component sleeve, wherein the radial opening is fabricated as an end-side axial cutout in the connecting region in at least one of the component sleeves. This results in the advantages described above.

The axial cutout is preferably produced in a master forming process. This may be done in a simple and cost-effective fashion by, for example, providing corresponding casting molds or injection molds. Later metal-cutting processing of the core sleeve to produce the radial opening is dispensed with.

The invention will be explained in more detail below with reference to the drawing, in which:

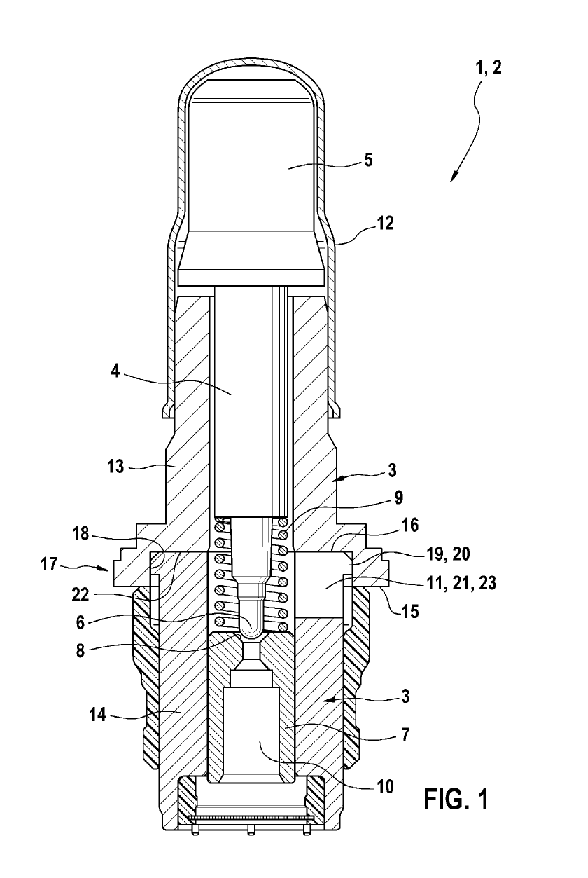

FIG. 1 shows an advantageous solenoid valve in a longitudinal sectional illustration, and

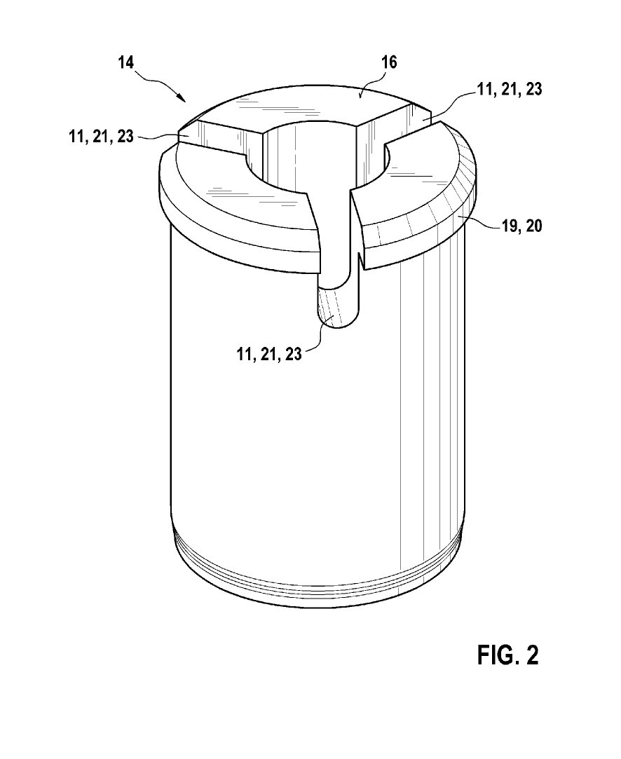

FIG. 2 shows a component sleeve of the solenoid valve in a perspective illustration.

FIG. 1 shows a solenoid valve 1 in a simplified longitudinal sectional illustration. The solenoid valve 1 is embodied as what is referred to as a valve 2 which is open in the currentless state for a hydraulic system of a motor vehicle, in particular for a brake system, such as for example an ESP, ABS or TSC system. The solenoid valve 1 has a core sleeve 3 in which a valve needle 4 is arranged in a longitudinally slideable or axially displaceable fashion. The valve needle 4 has at its end lying opposite its valve tip a solenoid armature 5. The valve needle interacts by means of its valve tip 6 with a valve seat 8 which is formed in a valve body 7 which is held in the core sleeve 3. A helical spring 9, which rests with one end on the valve body 7 and at its other end on an axial stop of the valve needle 4, forces the valve needle 4 away from the valve seat 8, with the result that in the non-activated state of the solenoid valve 1 a through-flow cross section is cleared. When the solenoid valve 1 is opened, fluid can flow in through an axial inflow duct 10 in the solenoid valve 1 and out of the solenoid valve 1 again through a radial opening 11. The valve needle 4 can be moved against the valve seat 8 by solenoid actuators (not illustrated in more detail here).

To provide a seal toward the outside, the solenoid valve 1 is surrounded by a housing cap 12 which surrounds the solenoid armature 5 completely and the core sleeve 3 in certain areas.

The core sleeve 3 is embodied in two parts and has for this purpose a first component sleeve 13 and a second component sleeve 14 which are arranged axially one behind the other, wherein the component sleeve 13 adjoins with its end side 15 the end side 16 of the component sleeve 14.

The first component sleeve 13 has, in the connecting region 17, an axial receptacle 18 in which the component sleeve 14 rests in certain areas. The component sleeve 14 has at its end side 16 a radial projection 19 which extends over the entire circumference of the component sleeve 14 and therefore forms a radial web 20. The external diameter of the radial projection 19 corresponds here essentially to the internal diameter of the axial receptacle 18, with the result that in the connecting region the component sleeve 14 is held in the axial receptacle 18 at least essentially in a radially positively locking fashion. The longitudinal extent or axial extent of the radial projection 19 is made smaller here than the longitudinal extent or axial extent of the axial receptacle 18, with the result that the radial projection 19 rests completely in the axial receptacle 18.

The radial opening 11 which is arranged in the connecting region 17 is embodied as an end-side axial cutout 21 in the component sleeve 14. As is most clear from FIG. 2, the component sleeve 14 has, in its end side 16, three axial cutouts which are integrally molded in and are arranged distributed uniformly over the circumference of the component sleeve 14. The axial cutouts 21 have here a U-shaped longitudinal section which extends through the entire width of the casing wall of the component sleeve 14. The embodiment as an axial cutout 21 means that the radial openings 11 which are formed as a result are embodied open at the edges to the end side 16. During production, the axial cutouts 21 are preferably already taken into account during the master forming by a corresponding shaping casting and/or injection mold. As a result, the radial drilled holes 11 can be implemented particularly easily and cost-effectively. In the mounted state, as illustrated in FIG. 1, the axial cutouts 21 are closed off at their open end by the closed end side 15 or by the closed floor face 22 of the axial receptacle 18. The radial openings 11 are therefore formed or defined by the component sleeves 14 and 13. The radial openings 11 are advantageously embodied here, as illustrated, as elongate holes 23 which are oriented axially.

The component sleeves 13 and 14 are also caulked to one another in the connecting region 17 by a plastic deformation. For this purpose, through an at least essentially radial application of force, if force is applied to the component sleeve 13 in the region of the axial receptacle 18 by means of a corresponding tool in such a way that the material of the component sleeve 13 is forced or plastically deformed around the radial projection 19 in such a way that ultimately the component sleeve 13 engages around the radial projection 19 of the component sleeve 14 in a frictionally and positively locking fashion. Since the axial cutout 18 is made deeper than the radial projection 19 is high or wide, the material of the component sleeve 13 is also pressed into a rear seat behind the radial projection 19, as a result of which axial positive locking is ensured between the component sleeves 13 and 14 of the core sleeve 3. As a result of the caulking, high pressures may be present and tolerated in the solenoid valve 1, in particular when the solenoid valve 1 is closed. As a result of the caulking, which constitutes cold shaping, the two component sleeves 13 and 14 are attached to one another or one onto the other, in a cost-effective and simple way in order to form the core sleeve 3. It is therefore possible, for example, to maintain pressures up to 280 bar by means of the solenoid valve 1.

In total, a solenoid valve 1 is offered which can be produced easily and cost-effectively and nevertheless also withstands high pressures.

1. A solenoid valve, comprising:
a needle valve, and
a core sleeve in which the valve needle is arranged in a longitudinally displaceable fashion,
wherein the core sleeve has a casing wall that defines at least one radial opening
wherein the core sleeve has a first component sleeve and a second component sleeve which axially adjoins the first component sleeve, and
wherein the at least one radial opening is configured as an end-face axial cutout in a connecting region in at least one of the component sleeves.

2. The solenoid valve as claimed in claim 1, wherein the at least one radial opening is configured as an axially oriented elongate hole.

3. The solenoid valve as claimed in claim 1, wherein the first component sleeve and the second component sleeve are caulked to one another in the connecting region by plastic deformation.

4. The solenoid valve as claimed in claim 1, that wherein the first component sleeve has at an end side an axial receptacle in the connecting region, in which the second component sleeve rests in certain areas.

5. The solenoid valve as claimed in claim 1, wherein the second component sleeve has at least one radial projection extending over the circumference of the second component sleeve in the connecting region.

6. The solenoid valve as claimed in claim 5, wherein the axial extent of the at least one radial projection is smaller than the axial extent of the axial receptacle.

7. A method for manufacturing a solenoid valve which has a core sleeve in which a valve needle is configured to be arranged in a longitudinally displaceable fashion and which is provided with at least one radial opening, comprising:
forming the core sleeve from a first component sleeve and a second component sleeve which adjoins the first component sleeve, and
fabricating the radial opening as an end-side axial cutout in a connecting region in at least one of the component sleeves.

8. The method as claimed in claim 7, wherein the axial cutout is produced by a master-shaping process.

9. The solenoid valve as claimed in claim 5, wherein the at least one radial projection includes at least one a radial web.
